(19) United States
(12) Patent Application Publication
(10) Pub. No.: US 2007/0275586 A1
(43) Pub. Date: Nov. 29, 2007

(54) Connectors and contacts for transmitting electrical power

(76) Inventor: Hung Viet Ngo, Harrisburg, PA (US)

Correspondence Address: WOODCOCK WASHBURN, LLP, CIRA CENTRE, 12TH FLOOR, 2929 ARCH STREET, PHILADELPHIA, PA, 19104-2891, US

(21) Appl. No.: 11/441,856

(22) Filed: May 26, 2006

(51) Int. Cl. H01R 13/28

(52) U.S. Cl. 439/290

(57) ABSTRACT

A connector system includes a first connector, and a second connector that mates with the first connector. The same type of power contact is used in the first and second connectors.

### CROSS REFERENCE TO RELATED APPLICATIONS

This application is related to U.S. application Ser. No. 11/019,777, filed Dec. 21, 2004; and U.S. application Ser. No. 11/408,437, filed Apr. 21, 2006. The contents of each of these applications is incorporated by reference herein in its entirety.

### FIELD OF THE INVENTION

The present invention relates to electrical connectors, and contacts used therein, that are configured to transmit electrical power.

### BACKGROUND OF THE INVENTION

Connector systems for transmitting electrical power typically comprise a header connector, and a receptacle connector that mates with and receives a portion of the header connector. The header connector can include one or more power contacts that engage complementary one or more power contacts on the receptacle connector, to establish electrical and mechanical contact between the header and receptacle connectors.

The power contacts used in the header connector are usually configured differently than the power contacts used in the receptacle connector, due to the need to equip the power contacts of the two connectors with complementary mating features.

The requirement to manufacture two different types of power contacts for a header connector and a receptacle connector can necessitate the use of a second set of production tooling that would not otherwise be required. Assembly costs can also be driven higher by the use of two different types of power contacts, as different processes and machinery may be required to assemble the two types of power contacts.

The parts count, and the amount of inventory needed to support production can be greater for a connector system that includes two, rather than one type of power contact. Also, the use of two different types of power contacts can introduce the potential for human error in the production and assembly processes. For example, a power contact configured for the header connector may be erroneously installed in the receptacle connector when different types of power contacts are used in the header and receptacle connectors.

Consequently, an ongoing need exists for a connector system having the same type of power contacts in a header connector and a receptacle connector thereof.

### SUMMARY OF THE INVENTION

Preferred embodiments of connector systems include a first connector, and a second connector that mates with the first connector. The same type of power contact is used in the first and second connectors.

Preferred embodiments of power contacts comprise a first half having a first plate-like body member, and a first type of contact beam adjoining the first body member; and a second half having a second plate-like body member positioned beside the first body member, and a second type of contact beam adjoining the second body member and opposing the first type of contact beam.

Other preferred embodiments of power contacts comprise a straight contact beam, and an angled contact beam opposing and spaced apart from the straight contact beam.

Other preferred embodiments of connector systems comprise a first connector having a first housing, and a first power contact disposed in the first housing. The connector systems also comprise a second connector having a second housing, and a second power contact disposed in the second housing. The second power contact is matable with and substantially identical to the first power contact.

### BRIEF DESCRIPTION OF THE DRAWINGS

The foregoing summary, as well as the following detailed description of a preferred embodiment, are better understood when read in conjunction with the appended diagrammatic drawings. For the purpose of illustrating the invention, the drawings show an embodiment that is presently preferred. The invention is not limited, however, to the specific instrumentalities disclosed in the drawings. In the drawings:

FIG. 1 is a front perspective view of a header connector of a preferred embodiment of a connector system;

FIG. 2 is a front perspective view of a receptacle connector that mates with the header connector shown in FIG. 1;

FIG. 3 is a side view of the header and receptacle connectors shown in FIGS. 1 and 2 in a mated condition;

FIG. 4 is a front perspective view of a power contact of the header connector shown in FIGS. 1 and 3;

FIG. 5 is a rear perspective view of the power contact shown in FIG. 4;

FIG. 6 is a perspective view of the power contact shown in FIGS. 4 and 5, at the start of a mating sequence with an identical power contact of the receptacle connector shown in FIGS. 2 and 3;

FIG. 7 is a top view of the power contacts shown in FIGS. 4-6, at the start of the mating sequence;

FIG. 8 is a magnified view of the area designated “A” in FIG. 7;

FIG. 9 is a perspective view of the power contacts shown in FIGS. 4-8, in a fully mated condition;

FIG. 10 is a magnified top view of the area designated “B” in FIG. 9;

FIG. 11 is a perspective view of an alternative embodiment of the power contacts shown in FIGS. 4-10, at the start of a mating sequence;

FIG. 12 is a top view of the power contacts shown in FIG. 11, at the start of the mating sequence;

FIG. 13 is a magnified view of the area designated “C” in FIG. 12;

FIG. 14 is a perspective view of another alternative embodiment of the power contacts shown in FIGS. 4-10;

FIG. 15 is a side view of a receptacle connector that includes the power contact shown in FIG. 14, mated with the header connector shown in FIGS. 1 and 3;

FIG. 16 is a perspective view of another alternative embodiment of the power contacts shown in FIGS. 4-10;

FIG. 17 is a perspective view of another alternative embodiment of the power contacts shown in FIGS. 4-10;

FIG. 18 is a perspective view of another alternative embodiment of the power contacts shown in FIGS. 4-10;

FIG. 19 is a top view of another alternative embodiment of the power contacts shown in FIGS. 4-10;

FIG. 20A is a front perspective view of a first type of contact beam of another alternative embodiment of the power contacts shown in FIGS. 4-10; and

FIG. 20B is a front perspective view of a first type of contact beam of another alternative embodiment of the power contacts shown in FIGS. 4-10.

### DETAILED DESCRIPTION OF ILLUSTRATIVE EMBODIMENTS

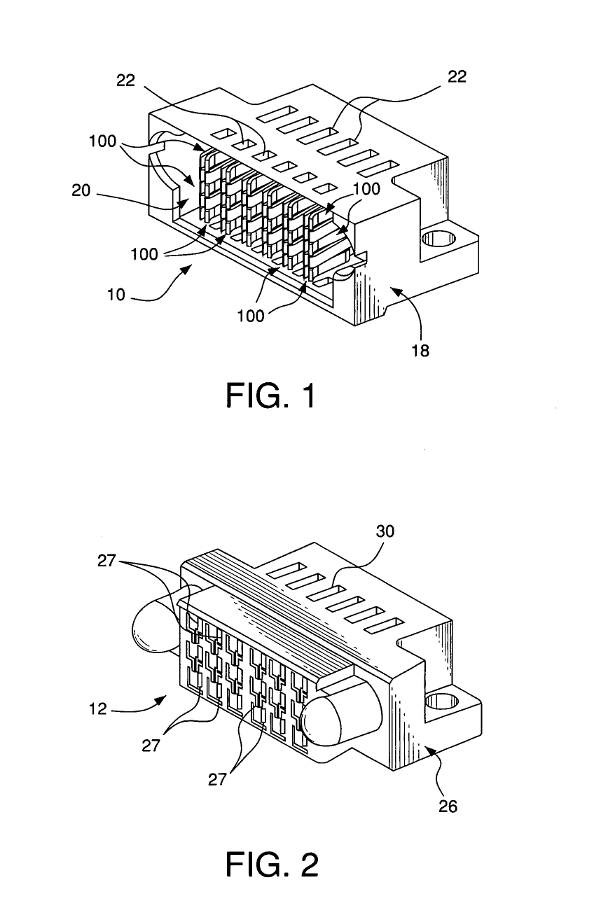

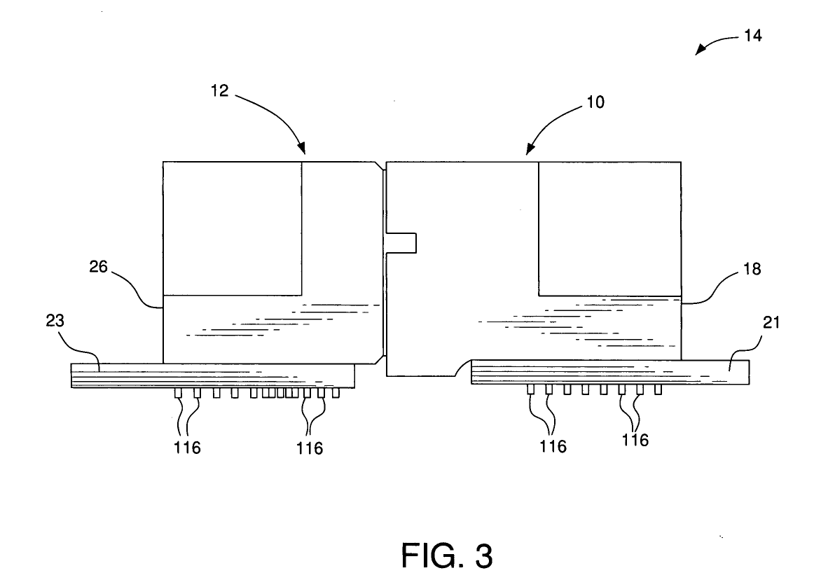

FIGS. 1 and 3 depict a preferred embodiment of a header connector 10. The header connector 10 comprises a plurality of power contacts 100. FIGS. 2 and 3 depict a preferred embodiment of a receptacle connector 12 that mates with the header connector 10. The receptacle connector 12 comprises a plurality of power contacts that are identical to, and mate with the power contacts 100 of the header connector 10. For clarity of illustration, the power contacts of the receptacle connector 12 are denoted by the reference character 100a in the figures. The header connector 10 and the receptacle connector 12 form a connector system 14.

The header connector 10 is depicted with six of the power contacts 100 for exemplary purposes only. Alternative embodiments of the header connector 10 can include more, or less than six of the power contacts 100. For example, alternative embodiments can include only one of the power contacts 100.

The header connector 10 can be mounted on a substrate 21, and the receptacle connector 12 can be mounted on a substrate 23, as shown in FIG. 3. The header and receptacle connectors 10, 12, when mated, can transmit electrical power between the substrates 21, 22.

The header connector 10 further comprises a housing 18. The housing 18 defines a cavity 20 in which the power contacts 100 are disposed. The housing 18 can have apertures 22 formed therein. Each aperture 22 extends between the cavity 20 and an upper exterior surface of the housing 18, from the perspective of FIG. 1. The apertures 22 help to dissipate heat generated by the transmission of electrical current through the power contacts 100, by channeling heated air from the cavity 20 to the environment around the header connector 10.

The receptacle connector 20 further comprises a housing 26. The housing 26 defines a cavity (not shown) in which the power contacts 100a are disposed. The housing 26 has openings 27 formed therein, to provide access to the power contacts 100a from the mating face of the housing 26.

The housing 26 can have apertures 30 formed therein. Each aperture 30 extends between the cavity within the housing 26, and an upper exterior surface of the housing 26. The apertures 30 help to dissipate heat generated by the transmission of electrical current through the power contacts 100a, by channeling heated air from the cavity to the environment around the receptacle connector 12.

The housing 18 and the housing 26 are preferably formed from an electrically and thermally-insulative material such as glass-filled high-temperature nylon. Alternative embodiments of the housing 18 and the housing 26 can be formed from materials that are not thermally insulative.

Details of the housing 18 and the housing 26 are presented for exemplary purposes only. The power contacts 100, 100a can be used in conjunction with other types of connector housings.

The power contacts 100 of the header connector 10 and the power contacts 100a of the receptacle connector 12 are identical, as discussed above. The following description of the power contact 100 therefore applies equally to the power contact 100a, unless otherwise noted.

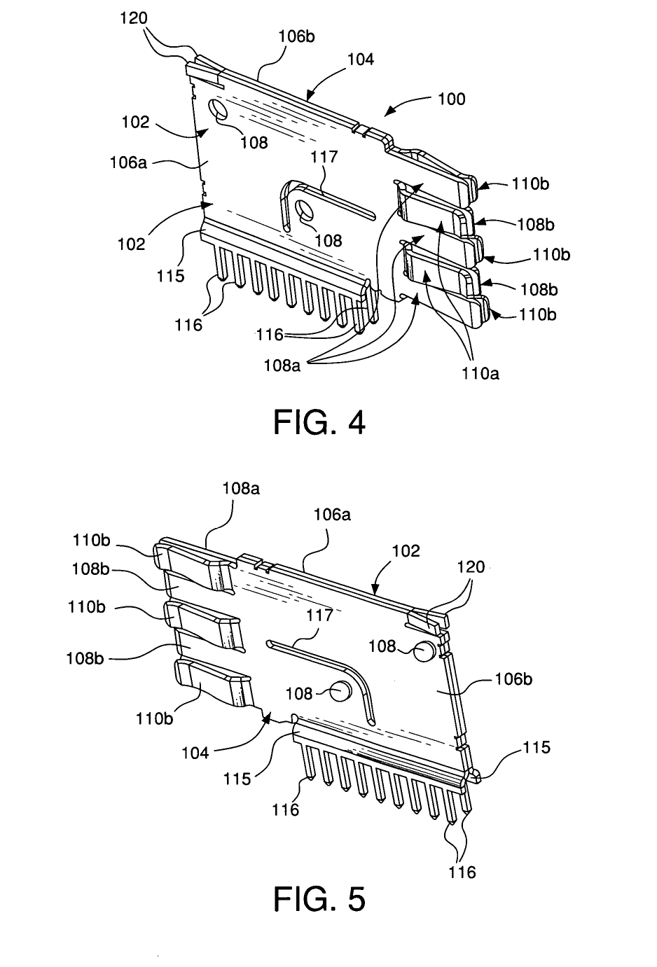

Each power contact 100 includes a first half 102 and a second half 104. The first half 102 includes a plate-like body member 106a. The second half 104 includes a plate-like body member 106b. The body members 106a, 106b oppose, or face each other, and are stacked against each other as shown in FIGS. 4 and 5. The body members 106a, 106b can be configured so that all, or a portion of the body member 106a is spaced apart from the body member 106b in alternative embodiments of the power contact 100.

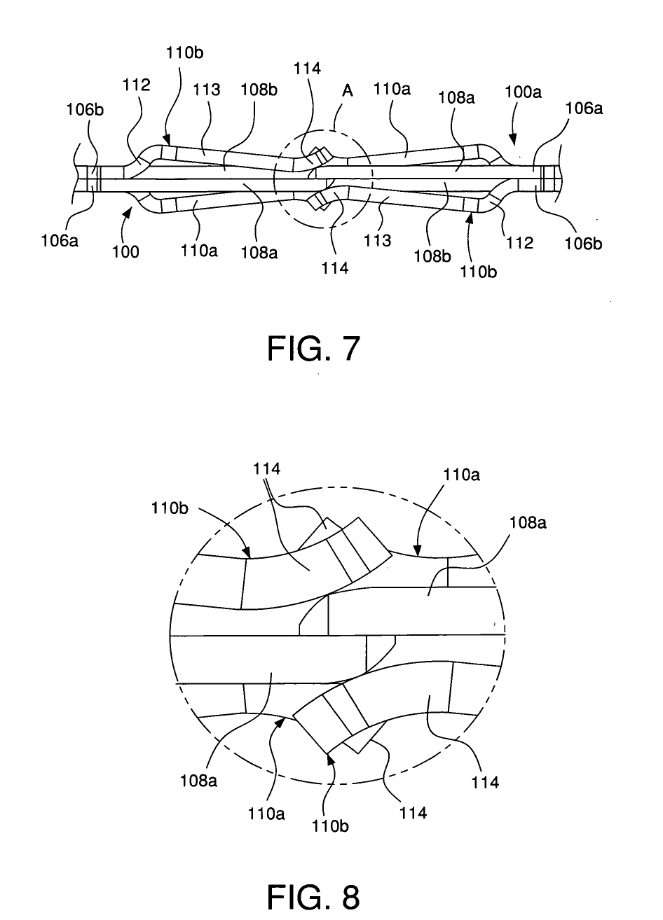

The first portion 102 includes a first type of contact beam in the form of three substantially straight contact beams 108a. The contact beams 108a each adjoin a forward end of the body member 106a, from the perspective of FIG. 4. The second portion 104 includes two substantially straight contact beams 108b that each adjoin a forward end of the body member 108b. A forward edge of each straight contact beam 108a, 108b is preferably rounded or curved, shown in FIGS. 7 and 8.

The first portion 102 further includes a second type of contact beam in the form of two angled contact beams 110a The second portion 104 further includes three angled contact beams 110b. Each angled contact beam 110a, 110b includes a substantially S-shaped portion 112 that adjoins the forward end of the associated body member 106a, 106b as shown in FIG. 7. Each angled contact beam 110a, 110b also includes a straight portion 113 that adjoins the associated angled portion 112, and a curved portion 114 that adjoins the associated straight portion 113. This configuration causes each of the angled contact beams 110a, 110b to extend outwardly and then inwardly along a length thereof.

The first half 102 of the power contact 100 is depicted with three of the straight contact beams 108a and two of the angled contact beams 110a for exemplary purposes only. The second half 104 is depicted with two of the straight contact beams 108b and three of the angled contact beams 110b for exemplary purposes only. Alternative embodiments of the power contact 100 can include first and second halves 102, 104 having any number of the straight contact beams 108a, 108b and angled contact beams 110a, 110b, including a single straight contact beam 108a, 108b and/or a single angled contact beam 110a, 110b.

The straight contact beams 108a and the angled contact beams 110a of the first half 102 are preferably arranged on the body member 106a in an alternating manner, i.e., each angled contact beam 110a is positioned adjacent to, and between two straight contact beams 108a as shown in FIG. 4. The straight contact beams 108b and the angled contact beams 110b of the second half 104 of the power contact 100 are preferably arranged on the body member 106b in an alternating manner, i.e., each straight contact beam 108b is positioned adjacent to, and between two of the angled contact beams 110b as shown in FIG. 5.

Each straight contact beam 108a of the first half 102 opposes, and is spaced apart from an associated one of the angled contact beams 110b of the second half 104, as shown in FIG. 4. This arrangement results in three pairs of opposing straight and angled contact beams 108a, 110b.

Each angled contact beam 110a of the first half 102 opposes, and is spaced apart from an associated one of the straight contact beams 108b of the second half 104. This arrangement results in two sets of opposing straight and angled contact beams 108b, 110a.

Each of the first and second halves 102, 104 preferably includes a substantially S-shaped portion 115 that adjoins a bottom edge of the body member 106a, 106b, as shown in FIGS. 4 and 5.

Each of the first and second halves 102, 104 also includes a plurality of terminal pins 116 that adjoin an associated one of the substantially S-shaped portions 115. The terminal pins 116 can be received in plated through holes or other features of the substrate 21 or the substrate 23, to establish electrical and mechanical contact between the header or receptacle connectors 10, 12 and the respective substrates 21, 23. The substantially S-shaped portions 115 each jog or flare outwardly in relation to their associated body member 106a, 106b, to provide an offset between the terminal pins 116 of the first half 102 and the terminal pins 116 of the second half 104.

The power contact 100 is depicted as a right angle contact for exemplary purposes only. Alternative embodiments of the power contact 100 can be configured with the terminal portions 115 extending directly or indirectly from a rearward edge of the associated body member 106a, 106b.

Each of the body members 106a, 106b can include current-guiding features, such as a slot 117 shown in FIGS. 4 and 5, to encourage even distribution of the electrical current flowing through the power contact 100 during operation thereof. Alternative embodiments of the power contact 100 can be formed without current-guiding features.

One or both of the body members 106a, 106b can include one or more projections 118. The projections 118 can be received in associated through holes formed in the other body member 106a, 106b, to help maintain the first and second halves 102, 104 in a state of alignment as the power contact 100 is inserted into the housing 18. Alternative embodiments of the power contact 100 can be formed without such alignment features.

Each body member 106a, 106b can include a tab 120 located at an upper rearward corner thereof. The tab 120 is angled outward, as shown in FIGS. 4 and 5. Each tab 120 can contact an associated lip (not shown) on the housing 18 as the power contact 100 is inserted into the housing 18 from the rearward side thereof during assembly of the header connector 10. Contact between the tab 120 and the lip causes the tab 120 to deflect inward. The tab 120 clears the lip as the power contact 100 approaches its fully-inserted position within the housing 18. The resilience of the tab 120 causes the tab 120 to spring outward, to its original position, once the tab 120 clears the lip. Interference between the tab 120 the lip can discourage the power contact 100 from backing out of the housing 18.

The power contact 100 can be formed from suitable materials known to those skilled in the art of electrical connector design. For example, the power contact can formed from a copper alloy. Other materials can be used in the alternative. The power contact 100 can be plated with various materials including, for example, gold, or a combination of gold and nickel.

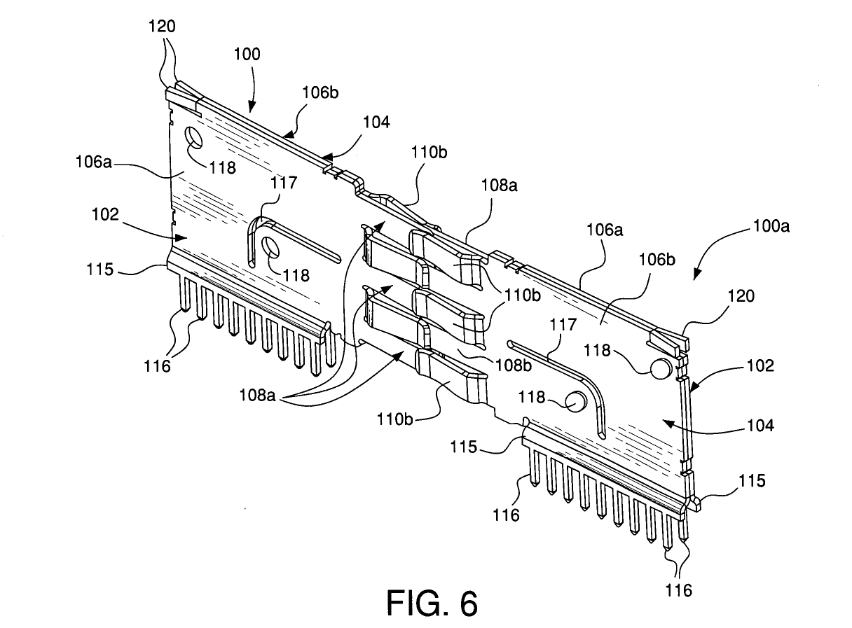

The power contacts 100 of the header connector 10 can each mate with an identical power contact 100a of the receptacle connector 12, as discussed above. FIGS. 6 through 10 depict the mating sequence of the power contacts 100, 100a.

The header connector 10 and the receptacle connector 12 are initially positioned so that the straight contact beams 108a, 108b and the angled contact beams 110a, 110b of the header connector 10 substantially align with associated openings 27 in the housing 26 of the receptacle connector 12. Movement of the header and receptacle connectors 10, 12 toward each other causes the forward edges of the straight contact beams 108a, 108b and the angled contact beams 110a, 110b of the header connector 10 to enter the housing 26 by way of the openings 27.

The forward edge of each straight contact beam 108a of the power contact 100a enters the space, or gap between an associated pair of opposing straight and angled contact beams 108a, 110b of the power contact 100 as the plug and receptacle connectors 10, 12 are moved further toward each other. The forward edge of each straight contact beam 108a of the power contact 100 simultaneously enters the space between an associated pair of opposing straight and angled contact beams 108a, 110b of the power contact 100a as the power contacts 100, 100a are moved toward each other.

Further movement of the power contacts 100, 100a toward each other causes each straight contact beam 108a to contact a curved portion 114 of an associated one of the angled contact beams 110b, as shown in FIGS. 7 and 8. Each pair of opposing straight and angled contact beams 108a, 110b is spaced apart so that the insertion therebetween of the associated straight contact beam 108a of the other power contact 100, 100a causes the angled contact beam 110b to deflect outwardly.

The rounded forward edge of each straight contact beam 108a can help to guide the straight contact beam 108a into the space between the associated pair of straight and angled contact beams 108a, 110b of the other power contact 100, 100a. In addition, the rounded forward edge urges the contacting angled contact beam 110b outward in a gradual manner.

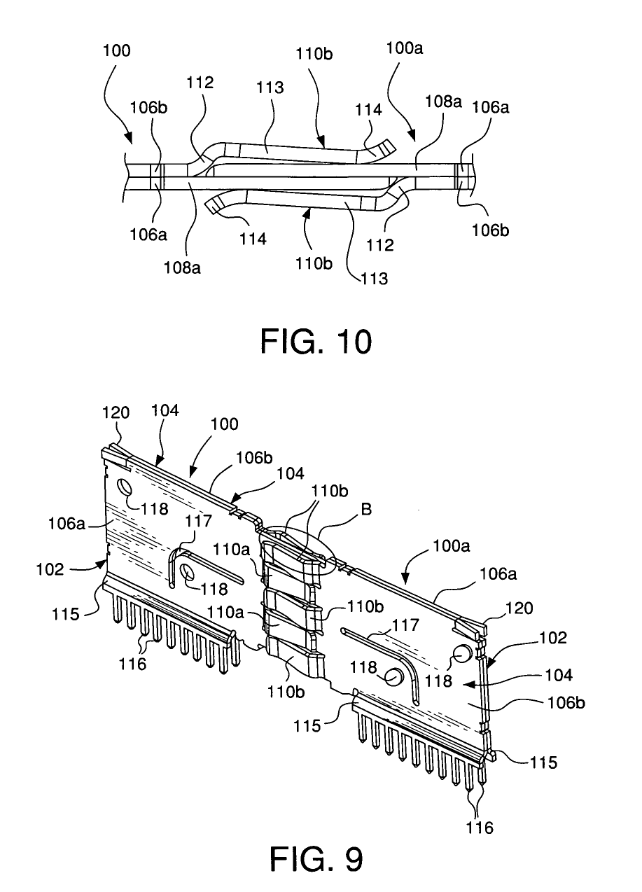

Continued movement of the power contacts 100, 100a toward each other causes the power contacts 100, 100a to eventually reach their fully mated positions depicted in FIGS. 9 and 10.

The straight contact beams 108a of both power contacts 100, 100a are disposed between the associated angled contact beams 110b of the power contacts 100, 100a when the power contacts 100, 100a are fully mated as shown in FIGS. 9 and 10. The angled contact beams 110b are spread outward by the straight contact beams 108a. The resilient deflection of the angled contact beams 110a generates a contact force between each angled contact beam 110a, and the contacting straight contact beam 108a. The contact forces urge the associated straight contact beams 108a against each other, and thus gives rise to an additional contact force between the straight contact beams 108a. These contact forces help to establish electrical contact between the power contacts 100, 100a. The contact forces also help to maintain the power contacts 100, 100a in a mated condition.

The power contacts 100, 100a can be configured so that the associated straight contact beams 108a are initially separated by a gap that closes as the above-noted contact forces urge the straight contact beams 108a toward each other, i.e., the associated straight contact beams 108a can deflect inwardly as the power contacts 100, 100a are mated. Alternatively, the power contacts 100, 100a can be configured so that the associated straight contact beams 108a contact each other at the start of the mating process, and remain in contact throughout the mating process.

The mating sequence for the straight contact beams 108b and the angled contact beams 110a of the power contacts 100, 100a is substantially identical to, and occurs on a simultaneous basis with the above described mating sequence for the straight contact beams 108a and the angled contact beams 110b.

The use of identical power contacts in a pair of header and receptacle connectors can obviate the need for two different sets of tooling to manufacture the power contacts, and can thereby help to minimize tooling costs. In addition, the use of identical power contacts can help to minimize production assembly costs, as the same processes and machinery can be used to assemble the power contacts of both the header and receptacle connectors.

The use of identical power contacts in the header and receptacle connectors of a connector system can help to minimize the amount of inventory needed to support production of the connector system, further reducing overall production costs. Moreover, the potential for human error associated with the use of different type of power contacts in a header and receptacle connector can be eliminated through the use of identical power contacts therein. For example, the use of identical power contacts in the header and receptacle connectors can substantially eliminate the possibility that a power contact suitable for use only in the header connector will mistakenly be installed in the receptacle connector.

The foregoing description is provided for the purpose of explanation and is not to be construed as limiting the invention. Although the invention has been described with reference to preferred embodiments or preferred methods, it is understood that the words which have been used herein are words of description and illustration, rather than words of limitation. Furthermore, although the invention has been described herein with reference to particular structure, methods, and embodiments, the invention is not intended to be limited to the particulars disclosed herein, as the invention extends to all structures, methods and uses that are within the scope of the appended claims. Those skilled in the relevant art, having the benefit of the teachings of this specification, may effect numerous modifications to the invention as described herein, and changes may be made without departing from the scope and spirit of the invention as defined by the appended claims.

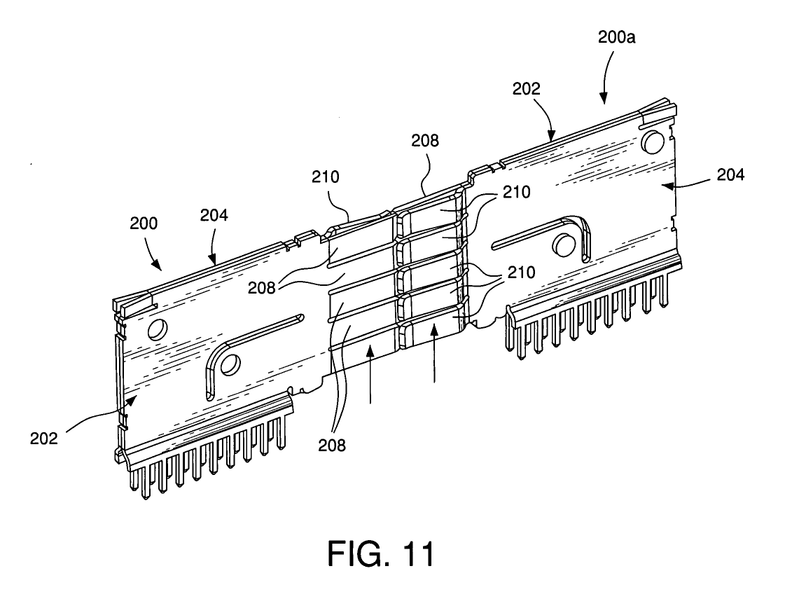

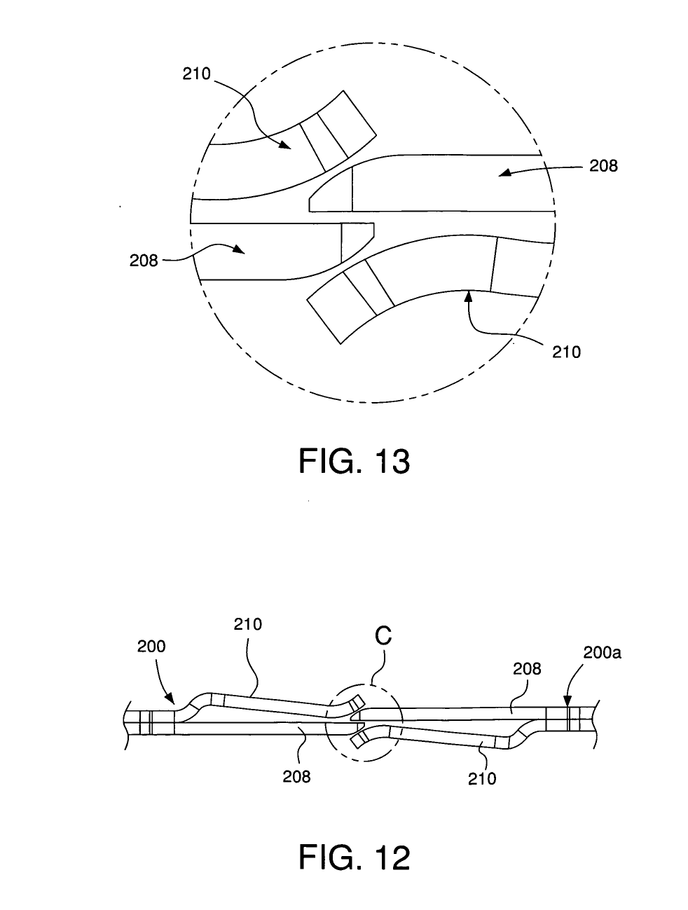

For example, FIGS. 11 through 13 depict an alternative embodiment of the power contacts 100, 100a in the form of power contacts 200, 200a. The power contacts 200, 200a are substantially identical to the power contact 100, with the exception that all of the straight contact beams 208 of the power contacts 200, 200a are positioned on a first half 202 of the power contacts 200, 200a, and all of the angled contact beams 210 of the power contacts 200, 200a are positioned on a second half 204 of the power contacts 200, 200a. The angled contact beams 210 and the straight contact beams 208 otherwise are substantially identical to the respective angled contact beams 110a, 110b and straight contact beams 108a, 108b of the power contact 100.

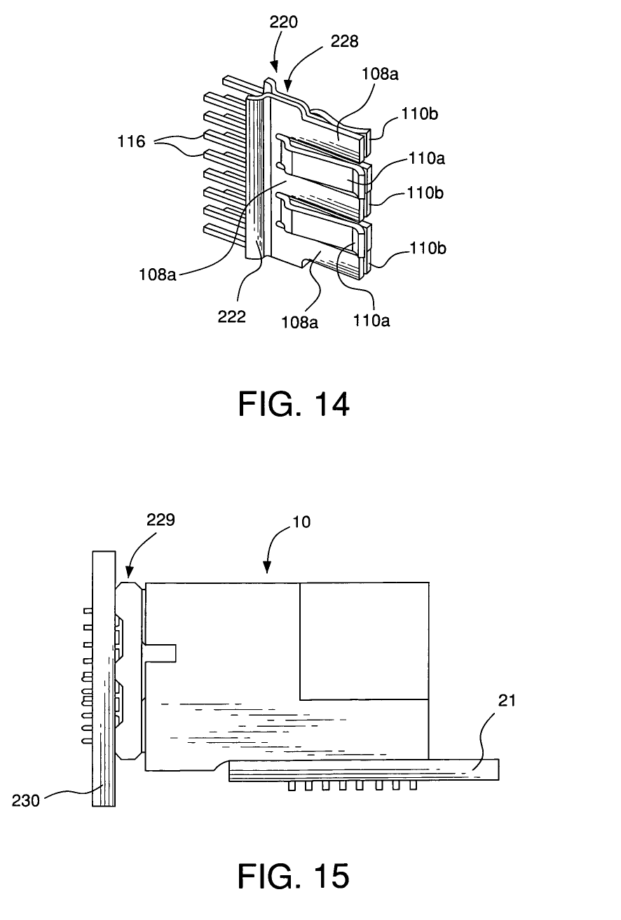

FIG. 14 depicts another alternative embodiment of the power contact 100 in the form of a power contact 220. The power contact 220 includes a first half 222 having three of the straight contact beams 108a and two of the angled contact beams 110a arranged as described above in relation to the power contact 100. The power contact 220 also includes a second half 228 having two of the straight contact beams 108b and three of the angled contact beams 110b arranged as described above in relation to the power contact 100.

The power contact 220 includes terminal pins 116 that extend rearward from the first and second halves 222, 228. The power contact 220 can be used as part of a receptacle connector 229 shown in FIG. 15. The receptacle connector 229 can mate with the header connector 10, and can be mounted on a substrate 230 that is substantially perpendicular to the substrate 21.

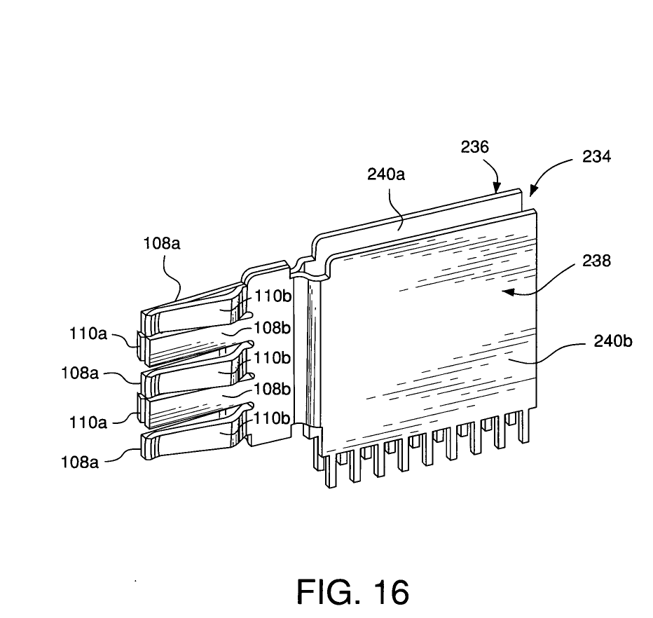

FIG. 16 depicts another alternative embodiment of the power contact 100 in the form of a power contact 234. The power contact 234 includes a first half 236 and a second half 238. The first half 236 comprises a plate-like body member 240a, and the second half 238 comprises a plate-like body member 240b. The body members 240a, 240b are spaced apart as shown in FIG. 16. Spacing the body members 240, 240b can help to dissipate heat from the power contact 234 during operation.

The first half 236 of the connector 234 can include three of the straight contact beams 108a and two of the angled contact beams 110a, arranged as described above in relation to the power contact 100. The second half 238 of the connector 234 can include two of the straight contact beams 108b and three of the angled contact beams 110b, arranged as described above in relation to the power contact 100.

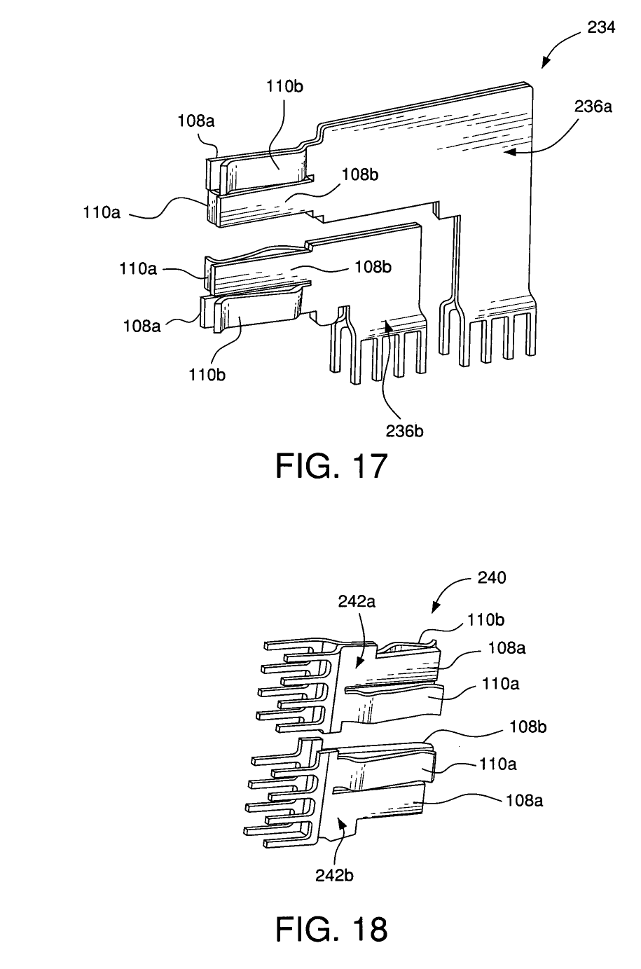

FIG. 17 depicts another alternative embodiment of the power contact 100 in the form of a power contact 234. The power contact 234 is substantially similar to the power contact 100, with the exception that the power contact 234 is divided into an upper half 236a and a spaced-apart lower half 236b, to encourage even distribution of the electrical current that flows through the power contact 234 during operation thereof. The power contact 234 includes straight contact beams 108a, 108b and opposing angled contact beams 110a, 110b, arranged in the manner discussed above in relation to the power contact 100.

FIG. 18 depicts another alternative embodiment of the power contact 100 in the form of a power contact 240. The power contact 240 is substantially similar to the power contact 220, with the exception that the power contact 240 is divided into an upper half 242a and a spaced-apart lower half 242b, to encourage even distribution of the electrical current that flows through the power contact 240 during operation thereof. The power contact 240 includes straight contact beams 108a, 108b and opposing angled contact beams 110a, 110b, arranged in the manner discussed above in relation to the power contact 100.

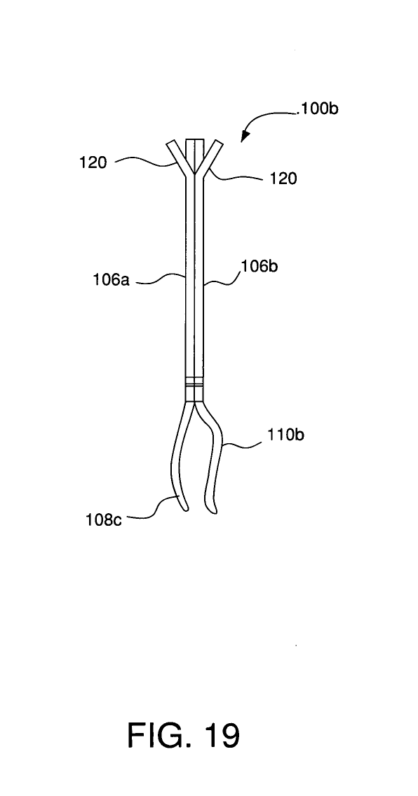

The first type of contact beams of the power contact 100 are depicted as straight contact beams 108a, 108b for exemplary purposes only. The first type of contact beams can have a configuration other than straight in alternative embodiments. For example, FIG. 19 depicts a power contact 100b comprising a first type of contact beam 108c having an arcuate shape in the lengthwise direction thereof. Components of the power contact 100b that are identical to those of the power contact 100 are denoted by identical reference characters in the figures. Only one contact beam 108c and one angled contact beam 110b are depicted in FIG. 19, for clarity of illustration. Other geometric configurations for the first type of contact beams can be used in other alternative embodiments.

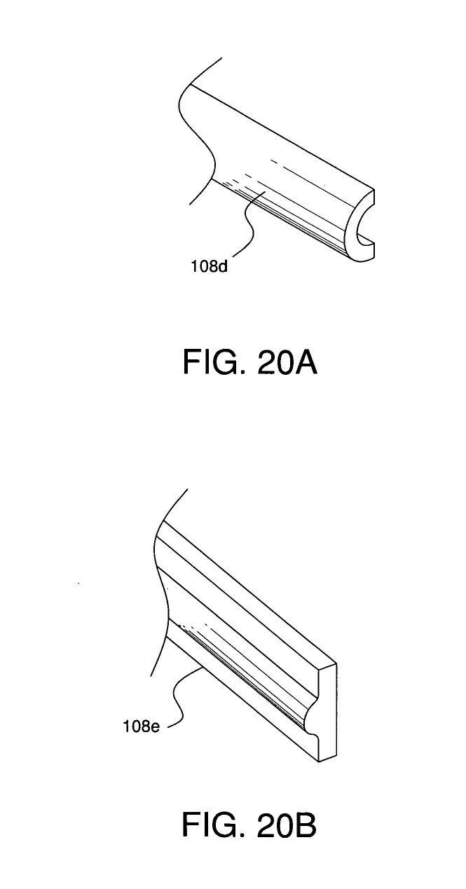

Moreover, the straight contact beams 108a, 108b are depicted as having a rectangular transverse cross section for exemplary purposes only. The first type of contact beams 108a, 108b of alternative embodiments can have transverse cross sections other than rectangular. For example, FIG. 20A depicts a first type of contact beam 108d having an arcuate transverse cross-section. FIG. 20B depicts a first type of contact beam 108e having a thickness that varies along the height of the contact beam 108e. Contact beams having other type of transverse cross sections can be used in other alternative embodiments. Moreover, the angled contact beams 110a, 110b can also be formed with cross sections other than rectangular in alternative embodiments.

Alternative embodiments (not shown) of the header and receptacle connectors 12, 14 can include one or more arrays of signal contacts. The signal-contact arrays can be positioned between, or to one side of the power contacts 100, 100a.

1. A power contact, comprising:
a first half comprising a first plate-like body member, and a first type of contact beam adjoining the first plate-like body member and having a major surface; and
a second half comprising a second plate-like body member positioned beside the first plate-like body member, and a second type of contact beam adjoining the second plate-like body member and having a major surface opposing the major surface of the first type of contact beam.

2. The power contact of claim 1, wherein the first type of contact beam is a straight contact beam, and the second type of contact beam is an angled contact beam.

3. The power contact of claim 2, wherein the angled contact beam extends outwardly and inwardly along a length of the angled contact beam.

4. The power contact of claim 1, wherein the plate-like body member of the first half is stacked against the plate-like body member of the second half.

5. The power contact of claim 2, wherein the first half further comprises a second angled contact beam adjoining the first plate-like body member and having a major surface, and the second half further comprises a second straight contact beam adjoining the second plate-like body member and having a major surface, wherein the major surface of the second angled contact beam of the first half opposes the major surface of the second straight contact beam of the second half.

6. The power contact of claim 1, wherein the first half further comprises a terminal pin that extends in a direction substantially perpendicular to a longitudinal axis of the first type of contact beam, and the second half further comprises another terminal pin that extends in a direction substantially perpendicular to a longitudinal axis of the second type of contact beam.

7. The power contact of claim 2, wherein a forward edge of each of the straight and angled contact beams is rounded.

8. The power contact of claim 2, wherein:
the first half further comprises three of the straight contact beams and two of the angled contact beams adjoining the first plate-like body member and arranged in an alternating manner on the first plate-like body member; and
the second half further comprises two of the straight contact beams and three of the angled contact beams adjoining the second plate-like body member and arranged in an alternating manner on the second plate-like body member.

9. A power contact, comprising a straight contact beam having a major surface, and an angled contact beam having a major surface opposing and spaced apart from the major surface of the straight contact beam.

10. The power contact of claim 9, further comprising a first and a second plate, wherein the straight contact beam is electrically and mechanically connected to the first plate, and the angled contact beam is electrically and mechanically connected to the second plate.

11. The power contact of claim 10, wherein the angled contact beam extends outwardly and inwardly along a length of the angled contact beam.

12. The power contact of claim 11, wherein the angled contact beam comprises an S-shaped portion that adjoins the second plate, a straight portion that adjoins the S-shaped portion, and a curved portion that adjoins the straight portion.

13. The power contact of claim 10, further comprising a second straight contact beam electrically and mechanically connected to the second plate and having a major surface, and a second angled contact beam electrically and mechanically connected to the first plate and having a major surface, wherein the major_surface of the second straight contact beam electrically and mechanically connected to the second plate opposes and is spaced apart from the major surface of the second angled contact beam electrically and mechanically connected to the first plate.

14. A connector system, comprising:
a first connector comprising a first housing, and a first power contact disposed in the first housing; and
a second connector comprising a second housing, and a second power contact disposed in the second housing, the second power contact being matable with and identical to the first power contact.

15. The connector system of claim 14, wherein the first and second power contacts each comprise a first type of contact beam, and a second type of contact beam that opposes the first type of contact beam.

16. The connector system of claim 15, wherein:
the first type of contact beam of the second power contact becomes disposed between the first and second types of angled contact beams of the first power contact when the first and second connectors are mated; and
the first type of contact beam of the first power contact becomes disposed between the first and second types of angled contact beams of the second power contact when the first and second connectors are mated.

17. The connector system of claim 16, wherein the first type of contact beam of the first power contact and the first type of contact beam of the second power contact cause the second type of contact beam of the first power contact and the second type of contact beam of the second power contact to deflect outward when the first and second connectors are mated whereby a contact force is generated between the first and second power contacts.

18. The connector system of claim 15, wherein the first type of contact beam is a straight contact beam and the second type of contact beam is an angled contact beam.

19. The connector system of claim 15, wherein each of the first and second power contacts further comprises:
a first half comprising at least one of the first type of contact beams and at least one of the second type of contact beams; and
a second half comprising at least one of the first type of contact beams that opposes the second type of contact beam of the first half, and at least one of the second type of contact beams that opposes the first type of contact beam of the first half.

20. The connector system of claim 14, wherein the first connector is a header connector and the second connector is a receptacle connector.
